(19) United States
(12) Patent Application Publication
(10) Pub. No.: US 2023/0375799 A1
(43) Pub. Date: Nov. 23, 2023

(54) ANNEALED SUBUNITS IN BUNDLED DROP ASSEMBLY AND PROCESS OF ANNEALING SUBUNITS IN BUNDLED DROP ASSEMBLY

(71) Applicant: CORNING RESEARCH & DEVELOPMENT CORPORATION, Corning, NY (US)

(72) Inventor: Corey Scott Keisler, Conover, NC (US)

(21) Appl. No.: 18/229,936

(22) Filed: Aug. 3, 2023

Related U.S. Application Data
(63) Continuation of application No. PCT/US2022/013962, filed on Jan. 27, 2022.
(60) Provisional application No. 63/146,783, filed on Feb. 8, 2021.

(51) Int. Cl. G02B 6/44

(52) U.S. Cl. CPC G02B 6/449; G02B 6/4486

(57) ABSTRACT

Embodiments of the disclosure relate to a bundled drop assembly. The bundled drop assembly includes a central member and a first layer of subunits wound around the central member in a bundled configuration. The first layer of subunits has at least one subunit containing at least one first optical fiber, and the first layer of subunits has a first maximum cross-sectional dimension in the bundled configuration. In an unrestrained configuration, the first layer of subunits has a second maximum cross-sectional dimension that is less than twice the first maximum cross-sectional dimension.

### CROSS-REFERENCE TO RELATED APPLICATION

This application is a continuation of International Application No. PCT/US2022/013962 filed Jan. 27, 2022, which claims the benefit of priority under 35 U.S.C. § 119 of U.S. Provisional Application Ser. No. 63/146,783, filed on Feb. 8, 2021, the content of which is relied upon and incorporated herein by reference in its entirety.

### BACKGROUND

The disclosure relates generally to bundled drop assemblies including optical fibers, and specifically to bundled drop assemblies in which subunits are annealed after being wound around an underlying central member or layer of subunits. Optical fibers are used to transmit data optically between various points in a network. Such optical fibers may be arranged in cables originating at data hubs, and the cables may include branches that drop at various locations to deliver data to nodes in the network. A variety of cable designs exist that provide such branching within a telecommunications network.

### SUMMARY

According to an aspect, embodiments of the disclosure relate to a bundled drop assembly. The bundled drop assembly includes a central member and a first layer of subunits wound around the central member in a bundled configuration. The first layer of subunits has at least one subunit containing at least one first optical fiber, and the first layer of subunits has a first maximum cross-sectional dimension in the bundled configuration. In an unrestrained configuration, the first layer of subunits has a second maximum cross-sectional dimension that is less than twice the first maximum cross-sectional dimension.

According to another aspect, embodiments of the disclosure relate to a method of preparing a bundled drop assembly. In the method, a first layer of subunits is wound around a central member into a bundled configuration. Each subunit of the first layer of subunits includes a first subunit jacket, and at least one subunit of the first layer of subunits contains an optical fiber disposed with the first subunit jacket. The first layer of subunits is annealed by heating each first subunit jacket to a temperature of at least 60° C.

According to a further aspect, embodiments of the disclosure relate to a bundled drop assembly that includes a central member, a first layer of subunits wound around the central member, and at least one further layer of subunits wound around the first layer of subunits. Each subunit of the first layer of subunits has a first subunit jacket, and at least one subunit of the first layer of subunits contains an optical fiber disposed within the first subunit jacket. Each subunit of the at least one further layer of subunits has a further subunit jacket, and at least one subunit of the at least one further layer of subunits contains an optical fiber disposed within the further subunit jacket. The at least one further layer of subunits is an outermost layer of the bundled drop assembly. One or both of the first subunit jackets or the further subunit jackets is annealed such that a residual unwinding force is less than 1000 g.

Additional features and advantages will be set forth in the detailed description that follows, and, in part, will be readily apparent to those skilled in the art from the description or recognized by practicing the embodiments as described in the written description and claims hereof, as well as the appended drawings.

It is to be understood that both the foregoing general description and the following detailed description are merely exemplary, and are intended to provide an overview or framework to understand the nature and character of the claims.

### BRIEF DESCRIPTION OF THE DRAWINGS

The accompanying drawings are included to provide a further understanding and are incorporated in and constitute a part of this specification. The drawings illustrate one or more embodiment(s), and together with the description serve to explain principles and the operation of the various embodiments.

FIG. 1 depicts a cross-section of a bundled drop assembly taken inline to a longitudinal axis of the bundled drop assembly, according to an exemplary embodiment;

FIG. 2 depicts a section of the bundled drop assembly showing the winding of the first and second layer of subunits, according to another exemplary embodiment;

FIG. 3 provides a flow diagram of a method of annealing the subunits in order to relief winding stress, according to an exemplary embodiment;

FIG. 4A depicts an experimental setup for measuring the splay of subunits from an optical fiber drop assembly;

FIG. 4B depicts the splay of subunits from an unannealed optical fiber drop assembly after having been cut according to the experimental setup in FIG. 4A; and

FIG. 5 depicts an experimental setup for measuring an unwinding force of subunits from an optical fiber drop assembly.

### DETAILED DESCRIPTION

Referring generally to the figures, various embodiments of a bundled drop assembly having annealed subunits are provided. As will be discussed more fully below, the bundled drop assembly includes a central member around which at least one layer of subunits is wound, and upon forming the layer of subunits around the central member, the subunits are annealed to relieve the stress developed in the subunits during winding. In this way, the subunits do not spring apart from the central member when the bundled drop assembly is terminated or accessed at a midspan location. Further, the method of annealing the subunits eliminates any requirement of a binder wrap or glue to keep the subunits wound around the central member, and the annealed subunits can be wound at longer laylengths, which enhances the processing speed for producing a bundled drop assembly. Exemplary embodiments of the bundled drop assembly and method of manufacturing same will be described in greater detail below, and these exemplary embodiments are provided by way of illustration, and not by way of limitation.

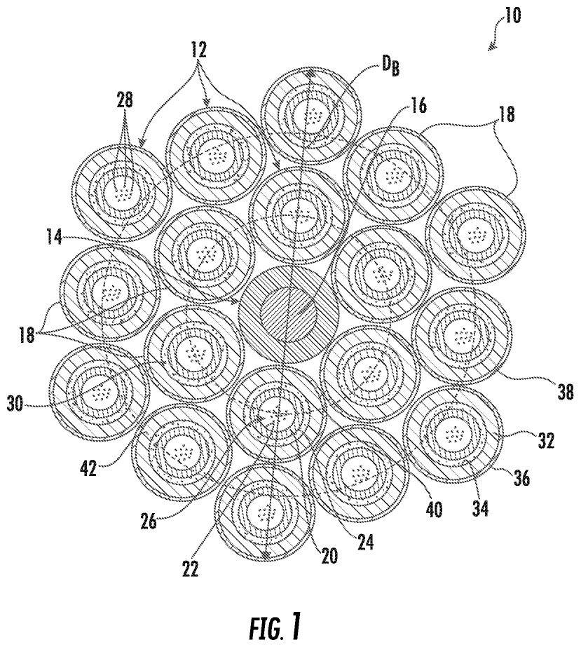

FIG. 1 depicts an exemplary embodiment of a bundled drop assembly 10. The bundled drop assembly 10 includes a plurality of subunits 12 wound around a central member 14. In the embodiment depicted, the central member 14 is a central strength member 16, including a central stiffening rod and a polymer upjacket. However, in other embodiments, the central member 14 may be, for example, an optical fiber cable (such as a loose tube or ribbon cable) or an electrical cable (such as a power transmission cable), among other possibilities. For example, in embodiments, the central member 14 may be an optical fiber cable central member carrying several hundred or even thousands of optical fibers (e.g., RocketRibbon™ cable, available from Corning Incorporated, Corning, NY). In embodiments, the diameter of the central member 14 is from 2 mm to 25 mm. For example, for central members 14 that are central strength members 16, the diameter may be in the range of about 2 mm to about 5 mm, with particular examples having diameters of 2.7 mm, 3.5 mm, 4.25 mm, and 5.0 mm. Further, for a central member 14 that is a cable, the diameter may be in the range of about 10 mm to about 25 mm, with particular examples having diameters of 10.22 mm, 11.63 mm, 13.05 mm, 14.5 mm, 17.4 mm, 18.8 mm, and 20.27 mm.

In the embodiment depicted, the subunits 12 are optical fiber drop cables 18. As can be seen in FIG. 1, each optical fiber drop cable 18 includes a buffer tube 20 having an inner surface 22 and an outer surface 24. The inner surface 22 defines a central bore 26 extending along a length of the optical fiber drop cable 18. Disposed within the central bore 26 are one or more optical fibers 28. In embodiments, each optical fiber drop cable 18 may comprise from one to thirty-six optical fibers 28. In particular embodiments, each optical fiber drop cable 18 includes optical fibers 28 in a multiple of twelve, such as twelve, twenty-four, or thirty-six optical fibers 28. In embodiments, the optical fibers 28 may be arranged in a loose tube configuration (as shown) or in one or more optical fiber ribbons. Additionally, in embodiments, the central bore 26 may also be filled with a variety of filling materials, such as strength members (e.g., aramid, cotton, basalt, and/or glass yarns), water blocking gels or powders, and/or fire retardant materials, among others. Further, in embodiments, the buffer tube 20 is made of a polymeric material, such as polybutylene terephthalate (PBT). In embodiments, the buffer tubes 20 comprise an outer diameter at the outer surface 24 of from about 2 mm to about 3 mm, with particular examples being about 2.85 mm and about 2.5 mm (+/−0.05 mm).

In the embodiment depicted, the subunits 12 include a layer 30 of strengthening yarns disposed around the buffer tube 20, and a subunit jacket 32 is provided around the layer 30 of strengthening yarns. In embodiments, the layer 30 of strengthening yarns may include a water-blocking feature, such as water blocking yarns or tape, or the strengthening yarns may be dusted with superabsorbent polymer powder. In embodiments, the layer 30 of strengthening yarns may include yarns of aramid, glass, cotton, or basalt, among others. The subunit jacket 32 includes an interior surface 34 and an exterior surface 36. In embodiments, the interior surface 34 is in contact with the layer 30 of strengthening yarns. Further, in embodiments, the exterior surface 36 is the outermost layer of the subunit optical fiber drop cable 18. In embodiments, the subunit jacket 32 is made of a low-shrink polymer composition containing a polyolefin, a thermoplastic elastomer, and a high-aspect ratio inorganic filler. Further, in certain embodiments, including the embodiment shown in FIG. 1, the optical fiber drop cable 18 includes a skin layer 38 of, e.g., high-density polyethylene (HDPE), which may be used to reduce the friction of the optical fiber drop cable 18 for cable blowing applications. In embodiments, the subunit 12 has an outer diameter as measured at the exterior surface 36 of the subunit jacket 32 or the outer surface of the skin layer 38 (if present) of about 4 mm to about 5 mm, with particular examples of about 4.0 mm and about 4.4 mm (+1-0.1 mm).

In the optical fiber drop cable 10, the subunits 12 are arranged in one or more layers around the central member 14. In the embodiment depicted, the subunits 12 are arranged in a first layer 40 and a second layer 42 around the central member 14. In the embodiment depicted, the first layer 40 is an inner layer, in particular the innermost layer, wrapped around the central member 14, and the second layer 42 is an outer layer, in particular the outermost layer, wrapped around the subunits 12 of the first layer 40.

In the embodiment depicted in FIG. 1, the first layer 40 includes six subunits 12. In embodiments, the first layer 40 includes from five to eighteen subunits 12. In embodiments, the number of subunits 12 in the first layer 40 depends at least in part on the diameter of the central member 14, i.e., a larger central member 14 will accommodate more subunits 12. Further, in the embodiment depicted in FIG. 1, the second layer 42 includes twelve subunits 12. In embodiments, the second layer 42 includes from eleven to twenty-four subunits 12. In embodiments, each successive layer of subunits 12 includes at least six more subunits 12 than the underlying inner layer (e.g., a first layer 40 of six subunits 12, a second layer 42 of twelve subunits 12, a third layer (not shown) of eighteen subunits 12, etc.). Each layer 40, 42 of subunits 12 defines a pitch circle (dashed line) which runs on average substantially through the center of each subunit 12 and which may be used as a reference for laylength of each layer 40, 42. “Laylength” as used herein refers to the linear length of the bundled drop assembly 10 over which the subunits 12 of each respective layer 40, 42 make one complete revolution around the central member 14 or other underlying layer.

As can be seen in FIG. 1, the second layer 42 of subunits 12 is the outermost layer of the bundled drop assembly 10. That is, unlike other optical fiber cables, the second layer 42 (or, more generally, the outermost layer) of subunits 12 is not surrounded by a cable jacket that encloses all of the subunits 12 of the bundled drop assembly 10 within a single structure.

Advantageously, because the subunits 12 are not surrounded by a cable jacket, dropping subunits 12 from the bundled drop assembly 10 is less time and labor intensive that opening a jacketed optical fiber cable at a splice or drop location. Instead, the subunits 12 are configured to drop from the bundled drop assembly 10 at various locations along the length of the bundled drop assembly 10. For the optical fiber drop cables 18, dropping off subunits 12 allows for delivery of optical signals through the optical fibers 28 to installations at the drop locations.

While the embodiment depicted shows only subunits 12 that are optical fiber drop cables 18, in other embodiments, the subunits 12 may be a mix of optical fiber drop cables 18, electrical conductor cables, and/or filler units. In embodiments, the electrical conductor cables include one or more wires contained in a subunit jacket configured to carry electrical current, and the electrical conductor cables can drop from the bundled drop assembly 10 at various locations to deliver electrical power to installations at the drop locations. In embodiments, the filler units are cords of solid or foamed polymeric material, which may be formed around one or more strengthening yarns. The filler units may be used to provide a complete layer of subunits 12 if not all subunit positions are needed for optical fiber drop cables 18 or electrical conductor cables. Additionally, in embodiments, the filler units may be provided along the bundled drop assembly 10 downstream of a drop location where an optical fiber drop cable 18 or electrical conductor cable drops off of the bundled drop assembly 10.

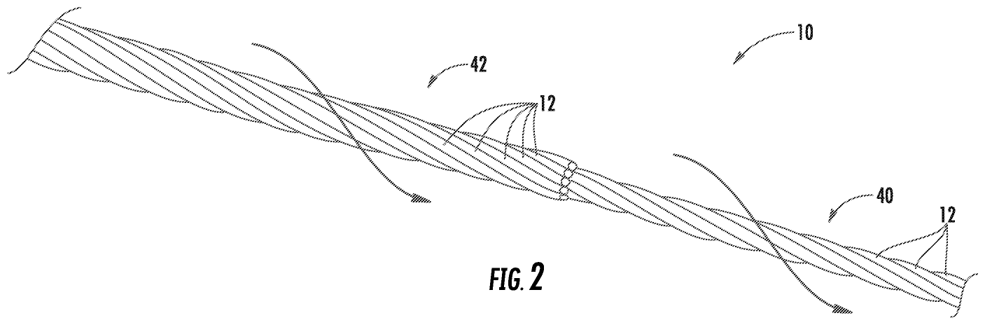

As shown in FIG. 1, the subunits 12 are wound in layers 40, 42 around the central member 14. FIG. 2 shows the direction of laying for the layers 40, 42. As can be seen in the embodiment depicted in FIG. 2, the layers 40, 42 are unidirectionally wound. That is, the layers 40, 42 are both wound in the same direction, e.g., both layers are wound in a clockwise or counterclockwise direction. Advantageously, Applicant has found that unidirectionally winding the layers 40, 42 allows the layers 40, 42 to loosen or tighten together when twisted, which prevents bulging of one layer out from the body of the bundled drop assembly 10 and/or subunits 12 of one layer cinching around the subunits 12 of another layer. Notwithstanding, the present disclosure applies as well to bundled drop assemblies 10 where layers 40, 42 of subunits 12 are counter stranded (e.g., one layer wound clockwise and an adjacent layer wound counterclockwise).

Stranding of the subunits 12 around the central member 14 and around underlying layers 40, 42 of subunits 12 builds up viscoelastic energy into the subunits 12. In particular, Applicant has found that six subunits 12 having a diameter of 4.4 mm wrapped around a 5.0 mm diameter central member at a laylength to pitch circle ratio of fifteen will exhibit an unwinding force of 1900 g. Thus, for example at the end of the bundled drop assembly 10 or if the bundled drop assembly 10 is cut, the subunits 12 have a tendency to unwind, splaying outwardly from the bundled drop assembly. For example, if the bundled drop assembly 10 has a maximum outer dimension D_{B} (shown in FIG. 1) as measured at the outermost layer of subunits 12 in a bundled configuration, the subunits 12 will splay outwardly in an unrestrained configuration to a maximum outer dimension that is more than four times the maximum outer dimension in the bundled configuration. Further, Applicant has found that the residual viscoelastic stress does not relax from the subunits over time even if the bundled drop assembly is wound on a reel for up to a week.

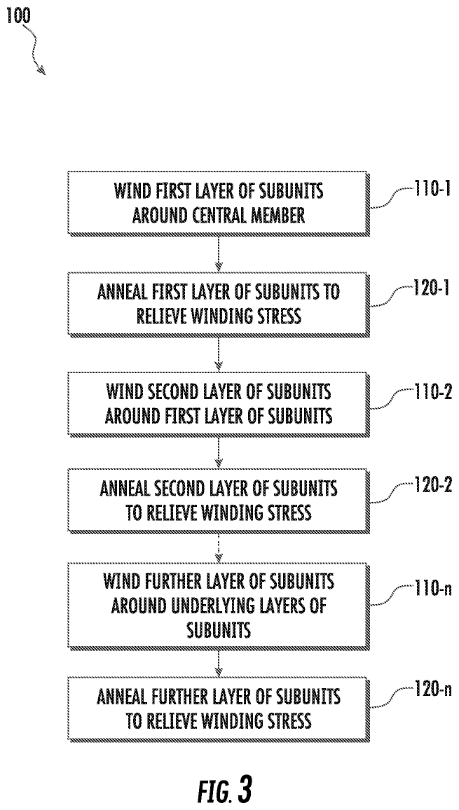

In order to address the issue of residual winding stress in the subunits 12, Applicant has found that annealing the subunits 12 after they are wound into the bundled drop assembly 10 relieves all or a substantial portion of the winding stress. FIG. 3 depicts a flow diagram of a method 100 of annealing the subunits 12 of the bundled drop assembly 10 (e.g., bundled drop assembly shown in FIGS. 1 and 2). In the method 100, a first winding step 110-1 involves winding a first layer 40 of subunits 12 around a central member 14. As mentioned above, the winding can be clockwise or counterclockwise. In general, the laylength during winding for the first layer 40 is kept at a maximum of fifteen times the pitch circle of the first layer 40, but as will be discussed more fully below, the annealing process allows the laylength to be longer, e.g., up to 21 times the diameter of the pitch circle of the first layer 40. In a first annealing step 120-1, the first layer 40 of subunits 12 is annealed to a temperature in a range of 60° C. to less than the melting temperature of the subunit jacket, in particular in the range of 60° C. to 90° C., more particularly about 80° C. (e.g., ±2° C.). In particular, the first annealing step 120-1 takes place in line with the winding, e.g., immediately downstream of the winding step. The annealing can be performed using a variety of heating apparatuses, such as radiant heaters, continuous furnaces, hot gas blowers, etc.

After the first layer 40 of subunits 12 is wound and annealed, the bundled drop assembly 10 may be taken up on a reel as completed (i.e., the bundled drop assembly 10 may only contain a single layer of subunits 12). For the embodiment depicted in FIGS. 1 and 2, though, the bundled drop assembly may be taken up on a reel for further winding of the second layer 42 on a separate processing line, or the bundled drop assembly 10 may continue on the same processing line for winding of the second layer 42 of subunits 12. In either case, the second layer 42 of subunits 12 is wound around the first layer 40 of subunits 12 in a second winding step 110-2 of the method 100. The second layer of subunits 12 may be wound in either the same rotational direction (as shown in FIG. 2) or a counter rotational direction as the first layer 40 of subunits 12. Thereafter, in a second annealing step 120-2, the second layer 42 of subunits 12 is annealed to a temperature in a range of 60° C. to less than the melting temperature of the subunit jacket, in particular in the range of 60° C. to 90° C., more particularly about 80° C. (e.g., ±2° C.). As with the first layer 40 of subunits 12, the annealing allows for longer laylengths of more than fifteen times the diameter of the pitch circle (e.g., up to 21×) for the second layer 42 of subunits 12.

After the second layer 42 of subunits 12 is wound and annealed, the bundled drop assembly 10 may be taken up on a reel as completed or for further winding of additional layers on a separate processing line. Further, the bundled drop assembly 10 may continue on the same processing line for winding of an additional layer of subunits 12. In either case, a further winding step 110-n is performed to add a further layer of subunits 12, and a further annealing step 120-n is performed to relieve the stress in the further layer of subunits 12. The winding 110-n and annealing 120-n steps are performed until the desired number of subunit layers are provided in the bundled drop assembly 10.

Advantageously, the annealed layers 40, 42 of subunits 12 substantially retain their bundled configuration without the use of binders, glues, or other retaining means. As compared to unannealed subunits that will unwind or straighten in an unrestrained configuration, the annealed subunits 12 according to the present disclosure will retain a corkscrew winding even if removed from the bundled drop assembly 10. Thus, for example, at the end of the bundled drop assembly 10 or at a cut location, the subunits 12 will not splay outwardly like the unannealed subunits. In embodiments, upon cutting the bundled drop assembly or at the end of the bundled drop assembly, the annealed subunits 12 will expand to a maximum cross-sectional dimension that is less than twice the maximum cross-sectional dimension D_{B} in the bundled configuration, in particular less than 1.5×the maximum cross-sectional dimension D_{B} in the bundled configuration, and more particularly less than 1.1×the maximum cross-sectional dimension D_{B} in the bundled configuration. In certain embodiments, upon cutting the bundled drop assembly 10 or at the end of the bundled drop assembly 10, the annealed subunits 12 will not expand at all such that the maximum cross-sectional dimension in the unrestrained configuration substantially equals the pre-cut-maximum cross-sectional dimension D_{B} in the bundled configuration.

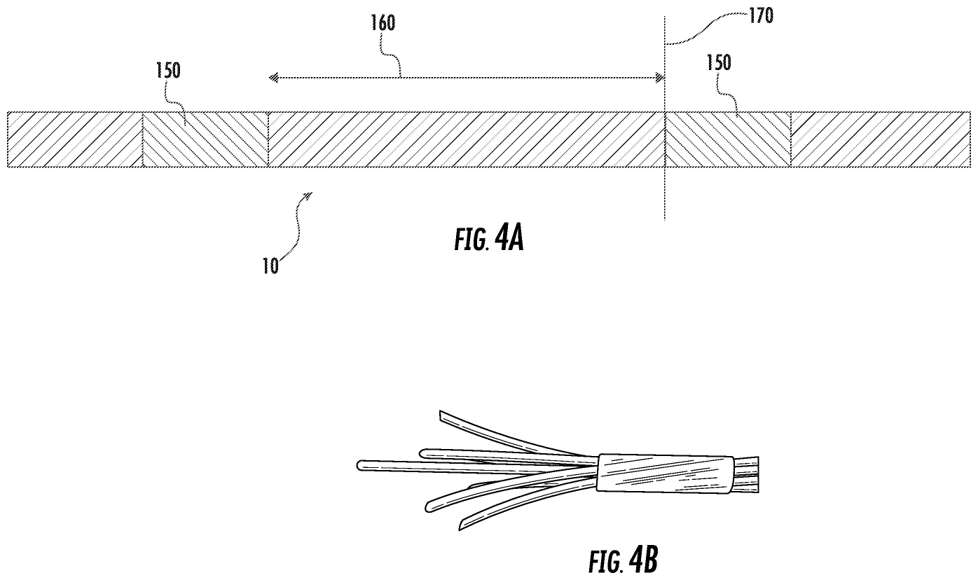

FIG. 4A depicts the manner in which the change in the maximum cross-sectional dimension D_{B} is determined. As shown in FIG. 4A, the bundled drop assembly 10 is bounded in a middle section using a binding wrap 150, such as tape. The bundled drop assembly 10 is then cut at a predetermined distance 160 from a cut line 170. In embodiments, the bundled drop assembly 10 may be bound with binding wraps 150 on the other side (right side in the orientation of FIG. 4A) of the cut line 170 to manage the subunits 12 of the bundled drop assembly 10. For a bundled drop assembly 10 having six subunits 12, each having a diameter of 4.4. mm, wrapped around a 5 mm central member 14 at a laylength to pitch circle ratio of fifteen, the predetermined distance 160 may be between 3 inches and 12 inches from the cut line 170. Upon cutting a bundled drop assembly, e.g., using cable cutters, the unannealed subunits will come unwound from the central member, splaying outwardly.

Applicant found that, for a bundled drop assembly having the parameters described, the initial maximum cross-sectional dimension of 13.1 mm will expand to 61.5 mm when the predetermined distance 160 to the cut line 170 is 3 inches, to 108.7 mm when the predetermined distance 160 to the cut line 170 is 6 inches, to 154 mm when the predetermined distance 160 to the cut line 170 is 9 inches, and to 279.4 mm when the predetermined distance 160 to the cut line 170 is 12 inches. At around 12 inches, it is believed that the weight of the subunits affects the splaying of the subunits from the central member, leading to the large jump in maximum cross-sectional dimension. FIG. 4B depicts a bundled drop unit having unannealed subunits splaying from the central member. The predetermined distance 160 to the cut line 170 for the bundled drop assembly shown in FIG. 4B was 3 inches. The maximum cross-sectional dimension is measured as the distance between diametrically arranged subunits. For a bundled drop assembly having six subunits, the maximum cross-sectional dimension may be averaged over the three sets of diametrically arranged subunits.

Further, Applicant has found that a bundled drop assembly 10 having six annealed subunits 12 with diameters of 4.4 mm wrapped around a 5 mm diameter central member at a laylength to pitch circle ratio of fifteen will exhibit an unwinding force of less than 1000 g, more particularly less than half that of a comparable bundled drop assembly having unannealed subunits. In particular, Applicant found that the unwinding force was about 550 g. That is, annealing the subunits will lower the unwinding force by at least 50%, in particular by at least 50%, and most particularly by about 70%.

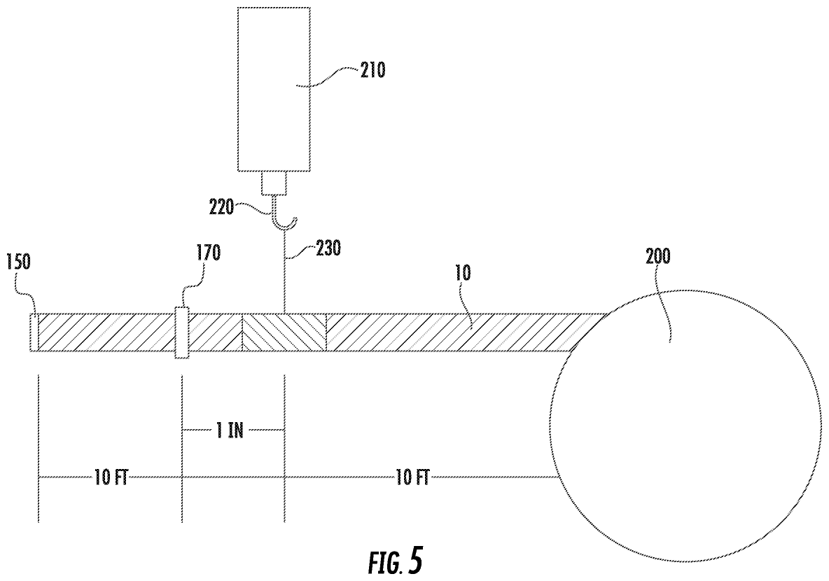

FIG. 5 depicts the manner in which the unwinding force is measured. As shown in FIG. 5, a section of the bundled drop assembly 10 having a length of 20 feet is unspooled from a reel 200. The free end of the bundled drop assembly 10 remains unsupported during testing and may be bound with a binding wrap 150. A force gauge 210 is positioned at the midpoint of the section of the bundled drop assembly 10 such that ten feet of the bundled drop assembly 10 is provided on either side of force gauge 210. The force gauge 210 includes a hook 220 to which one end of a string 230 is attached. The other end of the string 230 is wound around the bundled drop assembly 10 at the midpoint in three loops and may be secured with a piece of tape to prevent unwinding. The bundled drop assembly 10 is then cut, e.g., using a cable cutter, one inch from the midpoint. The force exerted by the subunits 12 on the string 230 is measured based on the pull of the string 230 on the hook 220 of the force gauge 210.

The bundled drop assembly 10 having annealed subunits as disclosed herein provides several advantages in processing, storage, and installation. In particular, by annealing the subunits 12, the subunits 12 will maintain their bundled configuration in the bundled drop assembly 10 without the need for binders or glue. Applying such binders or glue slows down the processing line speed, decreasing throughput. In contrast, the in-line heating apparatuses do not substantially slow down the processing line speed, and the annealing temperatures are sufficiently low that they do not significantly add to the processing cost. Further, the annealing allows for longer subunit laylengths, which increases processing speed. Additionally, the subunits 12 are able to remain in the bundled configuration without unwinding during storage. Similarly, during installation, the same concern of unwinding at an end of the cable or at a cut location is eliminated for a bundled drop assembly 10 having annealed subunits 12.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that any particular order be inferred. In addition, as used herein, the article “a” is intended to include one or more than one component or element, and is not intended to be construed as meaning only one.

It will be apparent to those skilled in the art that various modifications and variations can be made without departing from the spirit or scope of the disclosed embodiments. Since modifications, combinations, sub-combinations and variations of the disclosed embodiments incorporating the spirit and substance of the embodiments may occur to persons skilled in the art, the disclosed embodiments should be construed to include everything within the scope of the appended claims and their equivalents.

What is claimed is:

1. A bundled drop assembly, comprising:
a central member;
a first layer of subunits wound around the central member in a bundled configuration, the first layer of subunits comprising at least one subunit containing at least one first optical fiber and the first layer of subunits comprising a first maximum cross-sectional dimension in the bundled configuration;
wherein, in an unrestrained configuration, the first layer of subunits comprises a second maximum cross-sectional dimension that is less than twice the first maximum cross-sectional dimension.

2. The bundled drop assembly of claim 1, further comprising at least one further layer of subunits wound around the first layer of subunits, the at least one further layer of subunits comprising at least one subunit containing at least one second optical fiber;
wherein the at least one further layer of subunits comprises an outer layer of subunits that is an outermost layer of the bundled drop assembly.

3. The bundled drop assembly of claim 2, wherein the first layer of subunits and each of the at least one further layer of subunits is wound in a same rotational direction.

4. The bundled drop assembly of claim 1, wherein the first layer of subunits defines a pitch circle having a diameter and wherein a laylength of the first layer of subunits is more than fifteen times the diameter of the pitch circle.

5. The bundled drop assembly of claim 1, wherein the second maximum cross-sectional dimension that is less than 1.5× the first maximum cross-sectional dimension.

6. The bundled drop assembly of claim 1, wherein the first layer of subunits comprises a residual unwinding force of less than 1000 g.

7. The bundled drop assembly of claim 1, wherein the central member comprises at least one of a central strength member, an electrical cable, or an optical fiber cable.

8. The bundled drop assembly of claim 1, wherein the bundled drop assembly does not comprise a cable jacket or a binding wrap surrounding the first layer of subunits.

9. A method of preparing a bundled drop assembly, comprising:
winding a first layer of subunits around a central member into a bundled configuration, each subunit of the first layer of subunits comprising a first subunit jacket and at least one subunit of the first layer of subunits comprising an optical fiber disposed with the first subunit jacket;
annealing the first layer of subunits by heating each first subunit jacket to a temperature of at least 60° C.

10. The method of claim 9, wherein winding and annealing occur on a same processing line.

11. The method of claim 9, wherein the first layer of subunits defines a pitch circle having a diameter and winding further comprises winding the first layer of subunits around the central member at a laylength of more than fifteen times the diameter.

12. The method of claim 9, further comprising:
winding a second layer of subunits around the first layer of subunits, each subunit of the second layer of subunits comprising a second subunit jacket;
annealing the second layer of subunits by heating each second subunit jacket to a temperature of at least 60° C.

13. The method of claim 12, wherein winding the second layer of subunits further comprises winding the second layer of subunits in a same rotational direction as the first layer of subunits.

14. The method of claim 9, wherein annealing comprises relieving stress in the first subunit jackets so that a residual unwinding force is less than 1000 g.

15. The method of claim 9, wherein annealing comprises relieving stress in the first subunit jackets so that, in an unrestrained configuration, the first layer of subunits comprises a second maximum cross-sectional dimension that is less than twice a first maximum cross-sectional dimension in the bundled configuration.

16. The method of claim 9, wherein winding comprises winding the first layer of subunits around the central member of a central strength member, an electrical cable, or an optical fiber cable.

17. A bundled drop assembly, comprising:
a central member;
a first layer of subunits wound around the central member, each subunit of the first layer of subunits comprising a first subunit jacket and at least one subunit of the first layer of subunits comprising an optical fiber disposed within the first subunit jacket; and
at least one further layer of subunits wound around the first layer of subunits, each subunit of the at least one further layer of subunits comprising a further subunit jacket and at least one subunit of the at least one further layer of subunits comprising an optical fiber disposed within the further subunit jacket;
wherein the at least one further layer of subunits is an outermost layer of the bundled drop assembly; and
wherein one or both of the first subunit jackets or the further subunit jackets is annealed such that a residual unwinding force is less than 1000 g.

18. The bundled drop assembly of claim 17, wherein the central member comprises a central strength member, an optical fiber cable, or an electrical cable.

19. The bundled drop assembly of claim 17, wherein the first layer of subunits defines a pitch circle having a diameter and wherein a laylength of the first layer of subunits is more than fifteen times the diameter of the pitch circle.

20. The bundled drop assembly of claim 17, wherein the first layer of subunits comprises a first maximum cross-sectional dimension in a bundled configuration; and
wherein, in an unrestrained configuration, the first layer of subunits comprises a second maximum cross-sectional dimension that is less than twice the first maximum cross-sectional dimension.
